(19) United States
(12) Patent Application Publication
(10) Pub. No.: US 2011/0010742 A1
(43) Pub. Date: Jan. 13, 2011

(54) ENHANCED NETWORK SEARCH

(75) Inventor: Scott Anthony White, Austin, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/501,280

(22) Filed: Jul. 10, 2009

(51) Int. Cl. H04N 5/445; G06F 17/30

(52) U.S. Cl. 725/53

(57) ABSTRACT

A set-top box (STB) suitable for use with a multimedia distribution network is also provided with a broadband network connection to a server operated by the multimedia provider. The server contains electronic programming guide (EPG) information, and provides a highly-functional search interface accessible by the STB. Under normal conditions, when a user attempts to search EPG data, the STB will access the search interface and provide results to the user. The STB also has the ability to detect the status of the broadband network connection. If the broadband network connection is in a disconnected state, the STB will provide a reduced-functionality localized EPG search.

### BACKGROUND

1. Field of the Disclosure

The present disclosure relates to the field of multimedia content delivery, and more particularly to an enhanced network search for customer premises equipment (CPE).

2. Description of the Related Art

In a multimedia content distribution network (MCDN), a relatively high-powered master node such as a server may be connected to a relatively low-powered subordinate node such as CPE. Either or both nodes may include Electronic Programming Guide (EPG) information that a user may want to search to find a desired program or programs.

### BRIEF DESCRIPTION OF THE DRAWINGS

FIG. 1 is a network diagram of an exemplary embodiment of an MCDN, disclosing a method of providing network-enhanced search services;

FIG. 2 is a block diagram of an exemplary embodiment of a master node;

FIG. 3 is a block diagram of an exemplary embodiment of a subordinate node; and

FIG. 4 is a flow chart disclosing an exemplary method of providing network-enhanced search services.

### DESCRIPTION OF THE EMBODIMENT(S)

In a particular embodiment, a user may interact with a subordinate node on a MCDN. For example, the subordinate node may be CPE, including a set-top box (STB), which provides an EPG. When a user wants to search for a desired program, the user can interact with the subordinate node via a remote control or similar device to provide a search request. The search request may include key words joined by logical or other operators. In some MCDNs, EPG searches are always performed locally on the subordinate node. But the subordinate node may be optimized for factors such as multimedia display and low cost, making it less suitable for providing a robust, powerful, and fast searching mechanism. To enhance search operations, the search request may instead be forwarded, via a broadband connection, to a master node of the MCDN, which may be a more powerful computer better suited to performing to searching.

In some cases, however, the broadband connection joining the subordinate node to the master node may be degraded or completely lost. This may limit or destroy the ability for the subordinate node to forward the search request to the master node. In that case, the subordinate node may perform a local search, which may be slower, limited in scope, and less flexible than a search that could be performed on the master node. While performing the local, reduced-functionality search, the subordinate node may also notify the user that the broadband connection is not available, and provide instructions for restoring the connection so that better searches can be performed in the future.

Limited search may be slower, limited in scope, limited in the time slots searchable, limited to a smaller number of channels, limited to search fields (for example, titles only but not descriptions), limited in what operators can be used (for example, AND/OR only, whereas network search may provide more flexible options such as AND/OR/XOR/NOR/NOT, and even regular expressions or the like).

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

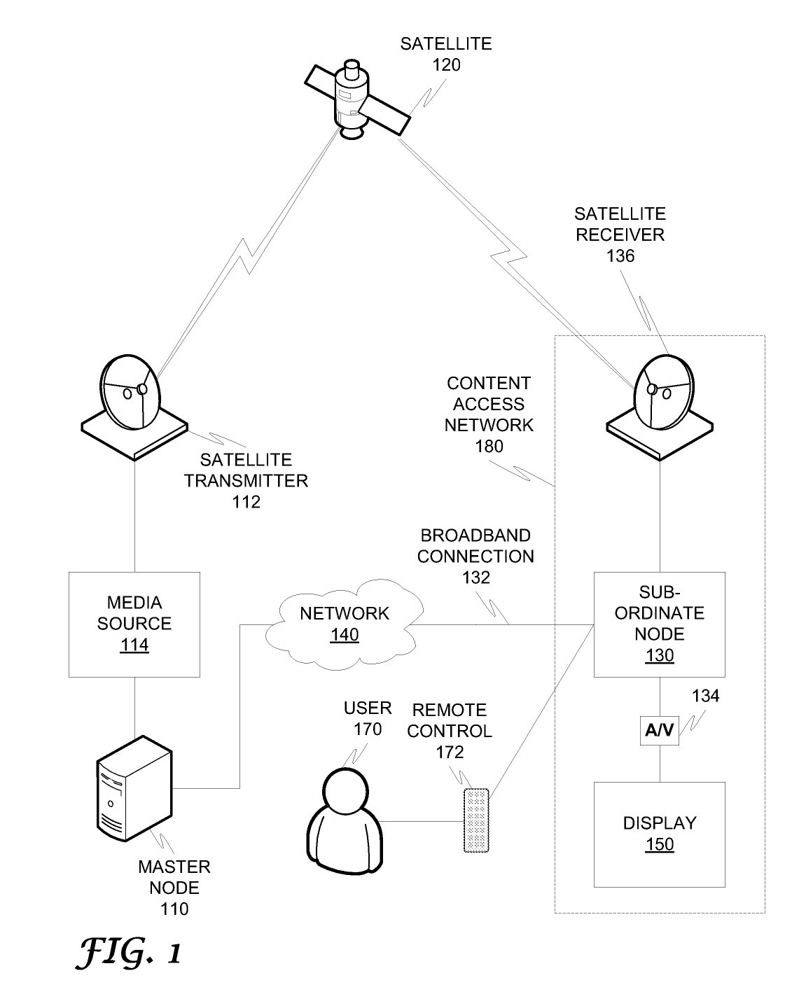

The present disclosure provides devices and methods for performing an enhanced network search from a subordinate node such as a CPE. In FIG. 1, a media source 114 is connected to an MCDN, which in one embodiment includes a satellite transmitter 112 transmitting to a satellite 120. Satellite 120 relays multimedia content to satellite receiver 136. A subordinate node 130, such as a CPE, including a set-top box (STB) decodes multimedia content received by satellite receiver 136. Subordinate node 130 provides an audio/video (A/V) stream 134 to a display 150, such as a television, monitor, or other display device. A user 170 views multimedia content on display 150, and is able to manipulate the functions of subordinate node 130 via a control device such as remote control 172. Subordinate node 130 may maintain a broadband connection 132 to network 140, which may be the internet, or any other suitable wide-area, private or other network. Network 140 may connect subordinate node 130 to a master node 110. Master node 110 may be a server, mainframe, or other high-powered computing device, and in some embodiments, will be substantially more powerful than subordinate node 130. Master node 110 may also be connected to media source 114, from which is may receive multimedia content and EPG data. Although the disclosed configuration is one of many possibilities, it should be noted that master node 110 and media source 114 represent logical demarcations, and while they may be separate physical devices, in some embodiments, media source 114 and master node 110 may be a single physical device, or media source 114 may be connected directly to master node 110, which may then stream multimedia data to satellite transmitter 112. Those having skill in the art will recognize other possible configurations, and it is not intended to limit the claims to the particular demarcations or interconnections disclosed here as an example.

When user 170 interacts with subordinate node 130 via remote control 172, one of the desirable actions may be searching EPG data for a desired program. For example, user 170 may be a fan of a particular show, a particular actor, a particular director, or a certain media genre. User 170 may want to record reruns of Star Trek on his digital video recorder (DVR). To find instances of “Star Trek,” EPG data will need to be searched. Because subordinate node 130 may have relatively limited processing power, if a local search is performed on subordinate node 130, user 170 may have limited options. For example, user 170 may be limited to searching only the titles of programs, and may be limited to a subset of possible search operators, such as literal or exact matches, or limited logical operators such as AND and OR. The user may also be limited to a default set of expanders. For example, a search for the string “Star Trek” may either return only literal matches, or may apply an expander, so that the search will also return “Star Trek: The Next Generation” and other later Star Trek series, without the ability for the user to change the default setting.

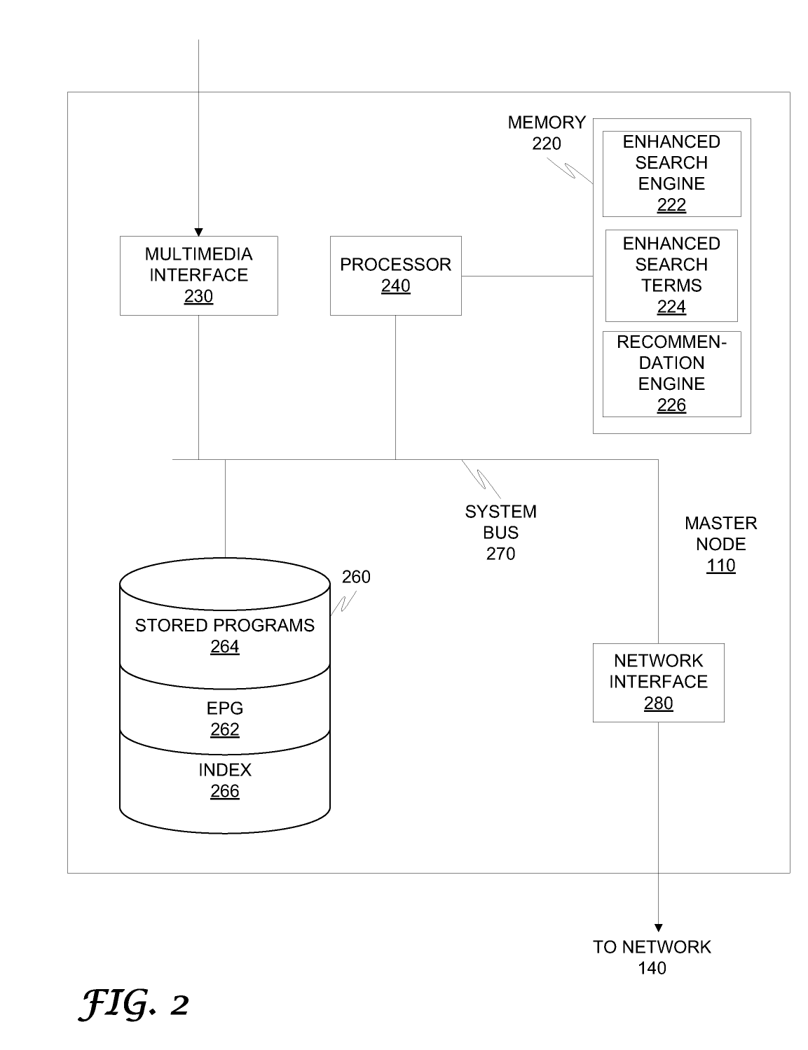

Preferably, a search request will be sent from subordinate node 130, over network 140 via broadband connection 132, to master node 110. Broadband connection 132 may be a digital subscriber line, cable connection, satellite connection, or other suitable broadband communication medium. Advantageously, master node 110 may be more powerful than subordinate node 130, and may be able to implement faster and more powerful search algorithms. Furthermore, master node 110 may have useful features such as pre-indexed EPG data, which will make searching faster, and may also benefit from a distributed EPG search process. Master node 110 may be able to handle complex search queries involving advanced logical operators, such as AND, OR, XOR, NOR, and NOT, or may permit advanced users to submit queries using complex “regular expressions,” root expanders, wild cards, or other advanced searching features. Such features may be difficult to implement on subordinate node 130 because of its more limited processing power. An advanced search on master node 110 may also return, in addition to the requested search results, additional logic based on a recommendation engine 226 (FIG. 2). For example, recommendation engine 226 may suggest that, in addition to Star Trek, user 170 may consider later programs from the Star Trek franchise, including later series, movies, or specials. User 170 may also consider other programs starring William Shatner or Leonard Nimoy, other material by Gene Roddenberry, or other programs in the “space opera” genres, such as Babylon 5 or Battlestar Galactica.

By connecting to master node 110, user 170 may also be enabled to perform “deep searches” that examine more than just the title (or other limited data set) of a program. For example, user 170 may be able to search for a particular actor, actress, director, producer, or genre. Persons having skill in the art will recognize other advanced search features that can be performed by a relatively powerful computing device such as master node 110.

FIG. 2 is a block diagram of an exemplary embodiment of a master node 110. Master node 110 includes a processor 240 communicatively coupled to a memory 220. Processor 240 may be any general-purpose, special-purpose, custom, or dedicated processing device, such as a microprocessor, microcontroller, field-programmable gate array (FPGA), digital signal processor (DSP), or application-specific integrated circuit (ASIC) by way of non-limiting example. Memory may be any low-latency data storage medium such as dynamic random access memory (DRAM), static random access memory (SRAM), cache, or flash memory by way of non-limiting example. Although memory 220 is shown as being directly connected to processor 240, as is typical in the classical Von Neumann architecture, persons having skill in the art will recognize that other viable architecture options are available, and that the disclosed interconnections for master node 110 are non-limiting examples. While master node 110 is performing enhanced search functions, memory 220 may hold an enhanced search engine 222, enhanced search terms 224 (which may have been supplied by user 170), and a recommendation engine 226.

Processor 240 is connected to a system bus 270, which provides an interface to system peripherals. Storage 260 may be a hard disk, optical medium, or other non-volatile, permanent, or long-term storage medium. Data saved to storage 260 may include stored programs 264, an EPG 262, and a pre-compiled index 266 of EPG data. Processor 240 may retrieve stored data from storage 260 as needed, and may load the retrieved data into memory 220. Processor 240 is also connected to a network interface 280, which provides a broadband connection to network 140. A multimedia interface 230 provides a connection to media source 114. Although multimedia interface 230 and network interface 280 are shown, in this example, as logically separate interfaces, the logical functions of both may be combined into a single physical interface in some embodiments. For example, in some embodiments, multimedia content may be provided over a broadband network, in which case multimedia interface 230 and network interface 280 may be a single physical device performing two logical functions.

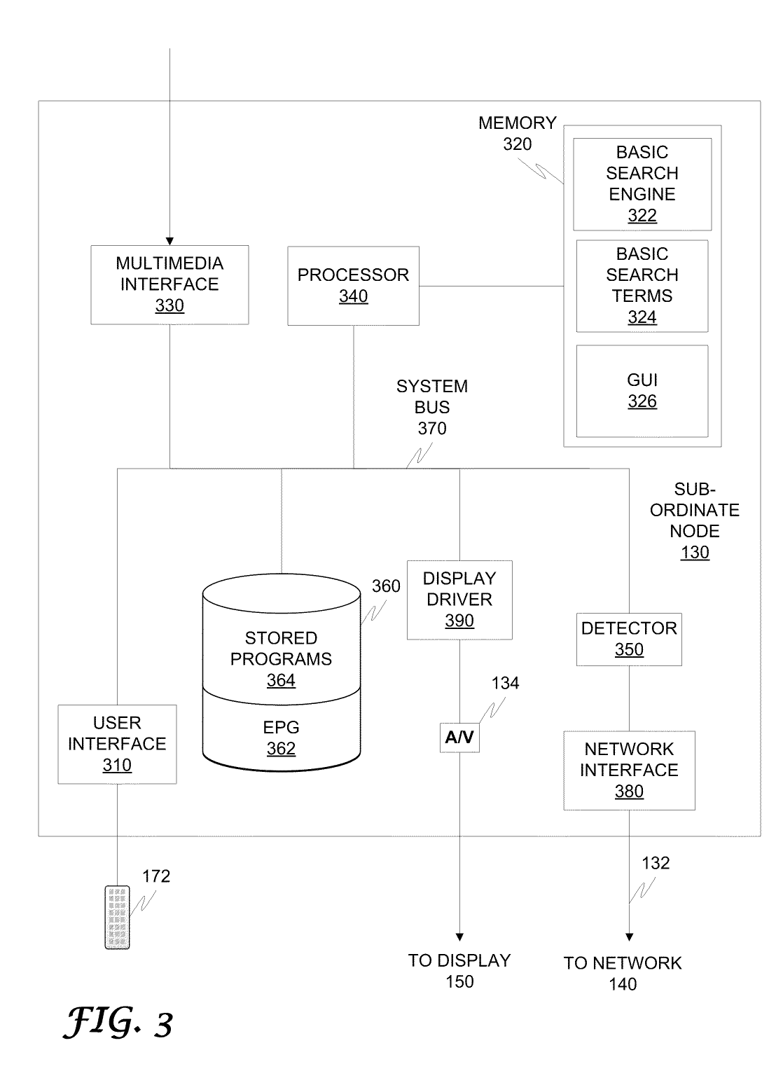

FIG. 3 is a block diagram of an exemplary embodiment of a subordinate node 130. Like master node 110, subordinate node is shown in this example as a computer based on the classical Von Neumann architecture, but is intended to encompass any computing device performing a same or similar function. In this example, a primary purpose of subordinate node 130 is to provide an A/V multimedia stream 134 to display 150. Because subordinate node 130 is optimized for this particular purpose, it may lack sufficient processing power to perform advanced search features like those performed by master node 110. In the disclosed embodiment, processor 340 is provided, and may be any processing device, as discussed in connection with master node processor 240 (FIG. 2). Processor 340 may be more particularly optimized for handling multimedia instructions. Processor 340 may be connected to memory 320, which may be any suitable memory device, as discussed in connection with master node memory 220 (FIG. 2). In the disclosed example, the only search-related contents of memory 320 are a basic search engine 322 and basic search terms 324. Memory 320 may also include instructions providing a graphical user interface (GUI) 326, which simplifies interaction with user 170.

Per the disclosed example, processor 340 connects to system peripherals via system bus 370. A display driver 390 provides an A/V multimedia stream 134 to display 150 based on instructions received from processor 340. Storage 360 may be a hard disk or other similar device as discussed in connection with master node storage 260 (FIG. 2). Storage 360 may include stored programs 364, which may include a stored basic search algorithm, and a local EPG 362.

A user interface 310 provides a physical layer for communication with user 170. For example, inputs from user 170 may be received from remote control 172 over user interface 310. Processor 340 may interpret the inputs, and provide elements of GUID 326 to display driver 390 to provide feedback to user 170. Processor 340 also receives multimedia data over multimedia interface 330, and may selectively drive portions of the multimedia data to display driver 390.

A network interface 380 provides a broadband connection to network 140. As with master node 110, network interface 380 and multimedia interface 330 may be two physically separate devices, or one physical device performing two logical functions. A detector 350 monitors the status of network interface 380. Detector 350 may be either a hardware device communicating with processor 340, a software algorithm stored in memory 320, or some combination of hardware and software. Detector 350 may provide processor 340 with a status for broadband connection 132 indicating that it is either working or not working. In some embodiments, detector 350 may provide a higher-resolution indication. For example, in addition to the binary “working” or “not working” status, detector 350 may be enabled to provide an indication of bandwidth, or a state of degradation of broadband connection 132.

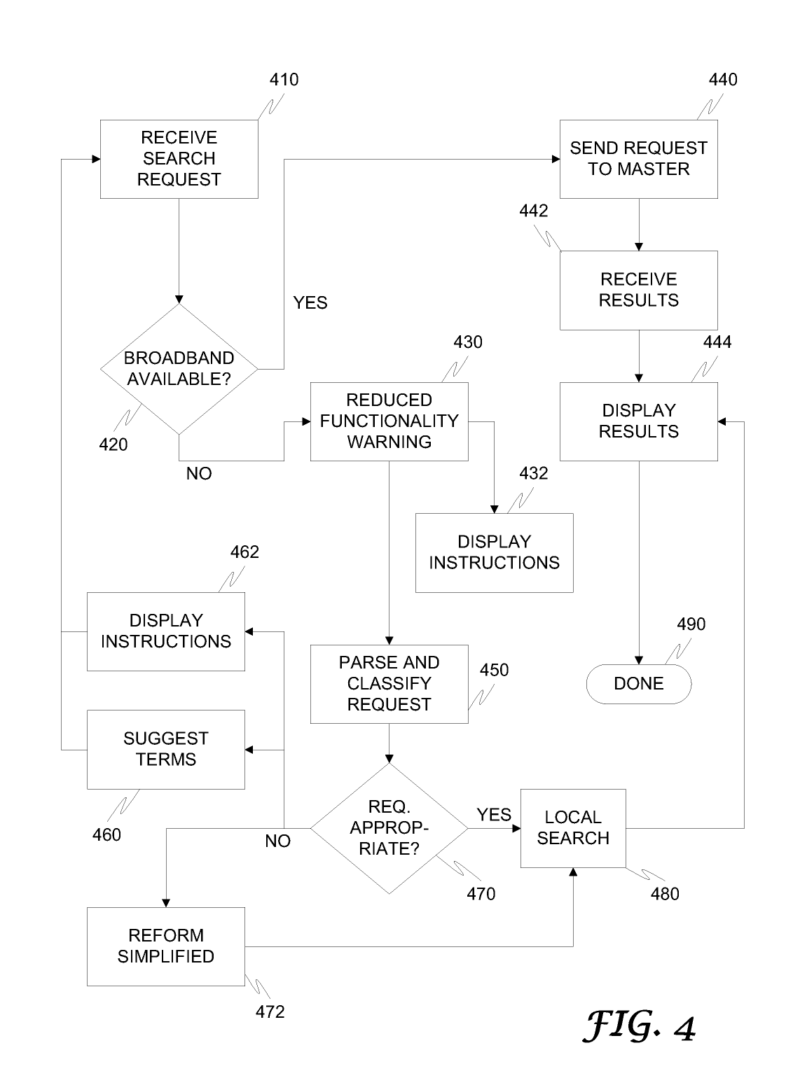

FIG. 4 is a flow chart showing an exemplary method that may, for example, be carried out in software by subordinate node 130. At block 410, a search request is received, for example from user 170. Decision block 420 is a status check to see if broadband connection 132 is available. In this context, availability or non-availability may be defined by binary “working” or “not-working” status, or by a more sophisticated algorithm that checks bandwidth and/or the state of degradation, and compares the results to the expected latency that will be experienced by forwarding the search request to master node 110. For example, if the connection is nominally available, but operating at such a low rate that the latency will be unacceptable to user 170, broadband connection 132 may be flagged as not available.

If broadband connection 132 is available, in block 440 the search request is forwarded to master node 110. Master node 110 processes the search request, and in block 442 subordinate node 130 receives search results. In block 444, the search results are displayed, for example by causing display driver 390 to display the results on display 150. The process then terminates in block 490.

If, according to decision block 420, the broadband connection is not available, the process falls back to a sub-optimal local search branch, starting with the display of a warning in block 430 that the broadband connection is not available and that a reduced-functionality search will be performed. In block 432, human-readable instructions for enabling, repairing, or troubleshooting broadband connection 132 may be displayed to user 170. In block 450, the search request is parsed. The search request may include search terms comprising one or more keywords and one or more operators. For example, the search string may be “Star Trek,” in which case the keywords are “Star” and “Trek,” and the logical AND operator may be implied, and a root expander may be implicitly applied to each term. This exemplary parsing would match any of the various members of the Star Trek franchise, as well as programs called, for example, Start Trekking or Start of the Trek. Another default parse method may be to treat the terms as a literal string not joined by an operator, in which case programs with the literal string “Star Trek” (such as member of the Star Trek franchise) will be matched, while Start Trekking and Start of the Trek would not be matched.

In another exemplary search, user 170 may attempt to perform a search using advanced search functions. For example, user 170 may attempt to perform a “deep search” of metadata fields other than title by specifying a particular actor, director, or genre. Or an advanced user 170 may attempt to search using regular expressions. For example, user 170 may want to find one of the Star Trek movies, and may search for the string “Star Trek” followed by a string consisting of only the letters “I” or “V.” Once the search request has been parsed, decision block 470 is a check to see if the search request is appropriate for a reduced-functionality local search. For example, the simple literal string searches may be classified as appropriate, whereas the advanced searches may be classified as inappropriate. If the search request is appropriate, then in block 480, a local search is performed, which may be slower, and/or of a more limited extent than an enhanced search on master node 110. After a local search is performed, in block 444 the results are displayed, and the results are displayed, after which the process terminates in block 490.

If the search request is not appropriate as determined by decision block 470, then one or both of two possible paths may be pursued. In block 472, the search request may be reformed into a simplified search request, for example by stripping advanced search features and performing a search appropriate for a local search. The reformed, simplified search may then be performed in block 480. The other option is in block 460, suggesting appropriate, simplified search terms, and in block 462 displaying human-readable instructions for forming a search string appropriate for a reduced-functionality local search. In this case, the process may return to the starting point at block 410 and await a new search request from user 170.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method of providing search services on a customer premises equipment, the method comprising:
receiving a search request;
detecting the status of a broadband connection to the customer premises equipment;
responsive to a first detected status of the broadband connection:
sending the search request to a master node;
receiving search results from the master node; and
displaying the search results on a display; and
responsive to a second detected status of the broadband connection:
providing a warning that a reduced-functionality search will be performed;
performing a local search of electronic programming guide information stored on the customer premises equipment; and
displaying the search results on a display.

2. The method of claim 1 further comprising:
responsive to the second detected status of the broadband connection, providing human-readable instructions for enabling the broadband connection.

3. The method of claim 1 further comprising:
responsive to the second detected status of the broadband connection, providing human-readable instructions for troubleshooting the broadband connection.

4. The method of claim 1 wherein the search request includes search terms, and the method further comprises:
responsive to the second detected status of the broadband connection, determining that the search terms are suitable for a reduced-functionality search.

5. The method of claim 1 wherein the search request includes search terms, and the method further comprises:
reformatting the search terms to be suitable for a reduced-functionality search.

6. The method of claim 1 wherein the search request includes search terms, and the method further comprises:
displaying human-readable instructions for creating search terms suitable for a reduced-functionality search; and
before performing the reduced functionality search, receiving revised search terms suitable for a reduced functionality search.

7. A subordinate node for use with a multimedia distribution network, the subordinate node comprising:
a processor configured to execute software instructions;
a broadband network interface communicatively coupled to the processor;
an output driver communicatively coupled to the processor; and
a storage medium containing electronic programming guide (EPG) data and further containing stored software instructions suitable for execution by the processor, the software instructions configured to instruct the processor to:
receive a search request;
detect a status of connection of the broadband network interface to a broadband network;
responsive to a first detected status:
send the search request to the broadband network over the broadband network interface;
receive search results from the broadband network over the broadband network interface; and
send the search results to the output driver;
responsive to a second detected status:
deliver a message to the output driver, the message indicating that the broadband network is not available and that a reduced-functionality search will be performed;
search the EPG data according to the search request; and
send results of the search to the output driver.

8. The subordinate node of claim 7 wherein the search request includes search terms and wherein the software instructions are further adapted to instruct the processor to:
classify the search terms; and
further responsive to the second detected status:
responsive to a first classification of the search terms, apply the search terms as received;
responsive to a second classification of the search terms, determine that the search terms are inappropriate for a reduced-functionality search;

9. The subordinate node of claim 8 wherein the search terms comprise key words and an operator, and wherein the instructions instruct the processor to classify the search terms according to the operator.

10. The subordinate node of claim 9 wherein the first classification of search terms is matched by the operator being one of AND and OR.

11. The subordinate node of claim 8 wherein the software instructions are further adapted to instruct the processor to, responsive to the determination that the search terms are inappropriate for a reduced-functionality search, recommend similar search terms that are appropriate for a reduced-functionality search.

12. The subordinate node of claim 8 wherein the software instructions are further adapted to instruct the processor to, responsive to the determination that the search terms are inappropriate for a reduced-functionality search, provide human-readable directions for forming search terms appropriate for a reduced-functionality search.

13. The subordinate node of claim 8 wherein the broadband connection is a digital subscriber line connection.

14. The subordinate node of claim 8 wherein the broadband connection is a cable connection.

15. A computer-readable medium containing software instructions, the software instructions configured to instruct a processor to:
receive a search request, the search request comprising keywords and at least one operator;
receive a signal representing a status of a broadband network connection;
responsive to a first status of the broadband network connection:
forward the search request to the broadband network connection; and
receive data representing a response to the search request;
responsive to a second status of the broadband network connection:
prepare a message indicating that the broadband network connection is not available; and
prepare human-readable instructions for making the broadband network connection available.

16. The computer-readable medium of claim 15 further comprising instructions to:
responsive to the second status of the broadband network connection perform a reduced-functionality search.

17. The computer-readable medium of claim 15 further comprising instructions to:
responsive to the second status of the broadband network connection:
classify the search request;
responsive to a first classification, perform a reduced-functionality search;

18. The computer-readable medium of claim 17 further comprising instructions to:
responsive to a second classification:
format a message indicating that a reduced-functionality search cannot be performed on the search request as received.

19. The computer-readable medium of claim 18 further comprising instructions to format a message, the message including human-readable instructions for forming a search request suitable for a reduced-functionality search.

20. The computer-readable medium of claim 18 further comprising instructions to:
receive a signal indicating that the search request may be modified; and
responsive to the signal, modify the search request by formatting a new search request suitable for a reduced-functionality search and containing terms substantially similar to the original search request.
